(19) United States
(12) Patent Application Publication
(10) Pub. No.: US 2014/0280912 A1
(43) Pub. Date: Sep. 18, 2014

(54) SYSTEM AND METHOD FOR DETERMINATION AND VISUALIZATION OF CLOUD PROCESSES AND NETWORK RELATIONSHIPS

(71) Applicant: Brendan Gregg, Walnut Creek, CA (US)

(72) Inventor: Brendan Gregg, Walnut Creek, CA (US)

(73) Assignee: Joyent, Inc., San Francisco, CA (US)

(21) Appl. No.: 14/203,421

(22) Filed: Mar. 10, 2014

Related U.S. Application Data
(60) Provisional application No. 61/780,774, filed on Mar. 13, 2013.

(51) Int. Cl. H04L 12/26

(52) U.S. Cl. CPC H04L 43/045
USPC 709/224

(57) ABSTRACT

A network monitoring system is provided that includes a process identification module, for instance DTrace, identifying internal service operations including processes, code paths, sockets, communications, connection establishments and/or storage operations. The network monitoring system also includes a visualization renderer of the socket-to-socket network elements providing a zoomable and filterable representation of a cloud operation.

### CROSS REFERENCE TO RELATED APPLICATIONS

This application claims the priority benefit of U.S. Provisional Application Ser. No. 61/780,774, filed on Mar. 13, 2013, titled “SYSTEM AND METHOD FOR DETERMINATION AND VISUALIZATION OF CLOUD PROCESSES AND NETWORK RELATIONSHIPS”, which is hereby incorporated by reference herein in its entirety including all reference cited therein.

### FIELD OF THE INVENTION

The present invention relates to systems and methods for managing a cloud computing infrastructure. In particular, the present system and method enables determination and visualization of cloud processes and network relationships.

### BACKGROUND

Cloud infrastructure, including storage and processing, is an increasingly important resource for businesses. Using a cloud infrastructure enables businesses to outsource all or substantially all of their information technology (IT) functions to a cloud service provider. Businesses using a cloud service provider benefit from increased expertise supporting their IT function, higher capability hardware and software at lower cost, and ease of expansion (or contraction) of IT capabilities.

Monitoring a cloud infrastructure is an important function of any cloud service provider, and continuity of function is an important selling point for any cloud service provider. Downtime due to malware or other failures must be avoided to ensure customer satisfaction. Cloud infrastructure monitoring conventionally includes network packet sniffing, but this is impractical as a cloud infrastructure scales up. Alternatively, host-based systems conventionally collect and aggregate information only regarding processes occurring within the host.

### SUMMARY

In one embodiment, the present technology is directed to a method for network monitoring using visualizations. The method may include: (a) obtaining, on a per-connection or a per-packet basis, for each zone in a cloud computing system, internal service operations attributes, the internal service operations attributes being stored in a log file; (b) aggregating the internal service operations attributes of the log files; and (c) converting the internal service operations attributes into a visualization of the cloud computing system, the visualization being zoomable and filterable.

In one embodiment, the present technology is directed to a network monitoring system for a cloud computing system, comprising: (a) a processor; and (b) a memory for storing executable instructions, the processor executing the instructions to: (i) identify internal service operations for zones of the cloud computing system, the internal service operations comprising any of processes, code paths, sockets, communications, connection establishments, input/output (I/O) operations, storage operations, and combinations thereof; and (ii) render a visualization of the internal service operations of the cloud computing system, the visualization being zoomable and filterable.

In one embodiment, the present technology is directed to a network monitoring system for a cloud computing system, comprising: (a) a processor; and (b) a memory for storing executable instructions, the processor executing the instructions to: (i) obtaining, on a per-connection or a per-packet basis, for each zone in the cloud computing system, internal service operations attributes, the internal service operations attributes being stored in a log file; (ii) aggregating the internal service operations attributes of the log files; and (iii) converting the internal service operations attributes into a visualization of the cloud computing system, the visualization being zoomable and filterable, the internal service operations attributes comprise, for each internal service operation a time stamp, an application name, a process ID, an application code path, or combinations thereof.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates an exemplary system for practicing aspects of the present technology;

FIG. 2 is a flowchart of an exemplary method for visual network monitoring; and

FIG. 3 illustrates an exemplary computing system that may be used to implement embodiments according to the present technology.

### DETAILED DESCRIPTION

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

FIG. 1 is a schematic diagram of an exemplary cloud computing system (system 100) that is constructed in accordance with the present technology. The system 100 may include a multi-tenant system 105 that may include a cloud-based computing environment. As stated above, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of servers, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

In some embodiments, the cloud includes a plurality of tenants 110A-N (e.g., zones), where each tenant may represent a virtual computing system for a customer. Each tenant may be configured to perform one or more computing operations such as hosting a web page, enabling a web-based application, facilitating data storage, and so forth.

In other embodiments, the multi-tenant system 105 may include a distributed group of computing devices such as servers that do not share computing resources or workload. Additionally, the multi-tenant system 105 may include a single computing device that has been provisioned with a plurality of programs that each produce instances of event data.

The multi-tenant system 105 may provide the tenants 110A-N with a plurality of computing resources, which may be either virtual or physical components. For the purposes of brevity, the following description may specifically describe a computing resource 130 that includes a physical storage media such as a hard disk. Again, the computing resource 130 may include physical devices that have operational constraints that can be defined in terms of a finite quantity. For example, an upper limit for the amount of I/O requests that can be handled by the computing resource 130 over a given period of time.

Customers or system administrators may utilize client devices 115 to access their tenant within the system 105. Additionally, the individual parts of the system 100 may be communicatively coupled with one another via a network connection 120. The network connection may include any number or combination of private and/or public communications media, such as the Internet.

A network monitoring system 135 is included in the system 105 and is configured to identify and gather internal service operations and their respective attributes over a given period of time. The network monitoring system 135 may itself be a tenant within the cloud or may be implemented as a process or tool that executes within the cloud, for example, using the computing resources of the cloud.

DTrace or another tool is executed against each tenant or zone in the cloud by the network monitoring system 135 to collect various internal service operations attributes that can be used to create the visualizations of the present technology. These processes will be described in greater detail below.

In general, multiple machines (zones) may be visualized, by communications between servers coupled to processes within a server or database. On the internal software of a virtual machine, database failovers, specific queries and database names may be visualized. Additionally, on the operating system of a server, latency, TCP/IP context and/or buffering information may be determined and visualized.

The network monitoring system 135 identifies processes including compute, store, and I/O in a distributed system running a UNIX operating system. The present technology uses a zone model with DTrace to identify processes between tenants within a cloud. These processes may be represented as socket-to-socket connections, processes, I/O operations, and so forth. In cloud systems that can facilitate billions of packets per second, packet sniffing may be prohibitive due to the amount of computing power required by packet sniffing. Since packet sniffing does not scale properly, it is usually only performed on a spot basis. Additionally, filtering based on the internal state of the target software is also not possible using a packet sniffing model.

For purposes of context, the present technology may utilize a debugging or troubleshooting tool that examines process level operations of zones (e.g., tenants). An example is DTrace, which is a dynamic tracing framework used as a troubleshooting tool. DTrace can be used to troubleshoot kernel and application problems on computer systems. Specifically in the present technology, DTrace can be used to troubleshoot problems within a cloud computing environment.

The network monitoring system 135 provides the capability to view tenants from the global zone, and may view establishment of connections instead of viewing individual packets. Also filtering for specific purposes is possible, without consuming too many network resources. Filtering for latency or any other appropriate metric, for instance load balancing, and identifying bottlenecks is also provided by the present technology.

The network monitoring system 135 quickens the process of debugging by providing a full picture of network relationships within zones. The present technology enables a system administrator to quickly and easily establish and visualize communications and network traffic by and between machines and/or processes on the network. Further, the network monitoring system 135 enables a system administrator to visualize the number of connections in a zone and the amount of processing power being used at particular nodes or for particular operations.

The network monitoring system 135 provides a visualization that shows connections between nodes in an overall picture that is zoomable and filterable. The network monitoring system 135 provides a network map of running processes, connections and dependencies to high degree of granularity, and on a system level view. Using the network monitoring system 135, it is possible to view every virtual machine running on every server in a datacenter build and color code based on communication protocol, and/or change size based on CPU and/or memory usage. The network monitoring system 135 enables the creation of a network/compute/data image representing key attributes of the cloud. The visualization enables user analysis that would be impossible to comprehend in text form, and therefore the image is critical for analyzing connections and usage.

For example, the visualization provides images of nodes that are isolated (representing broken nodes) and/or spawning inordinate numbers of processes (representing malware processes or debug issues). Darker nodes in the visualization may indicate busier nodes, and histographic and/or multi-dimensional analysis may be performed on the visualization data. Client-directed and/or malware may be more easily identified and/or remedied based on the visualization. Other problems easily identified using the network monitoring system 135 include, but are not limited to, log rotations, process hijacking, bottlenecks, and imbalances—just to name a few. The network monitoring system 135 also may be utilized as a starting point for an administrator directed or automated diagnosis and correction management scheme, for instance using graph search and/or transforming the data used in the visualization into an n-by-n matrix for further analysis.

Process level analysis within each zone may be used to observe processes within a zone and create a visualization of a multi-server system. The present technology identifies processes as well as misconfigurations, sub-optimalities and malware. The network monitoring system 135 views server-level communications, as well as internal server processes, including processes within virtual machines running on a server. The network monitoring system 135 can therefore combines visualizations of network traffic along with visualizations of process-level operations within a server and/or virtual machine. The information provided by the visualizations is derived directly from system operations, and not from a host monitor, and in this manner the complete information of socket-to-socket, or internal software instance to each other internal software instance. The network monitoring system 135 may be adapted to a real-time information gathering and visualizing system, and may be adapted to be used in an operations management system.

The network monitoring system 135 collects information from each machine and its running processes on either a per-connection or a per-packet basis, by instrumenting the software execution of network events. On each machine, this information shows one endpoint for a network connection, and can include useful information including a time stamp, the application name, process ID, application code path, and other metrics. Information from all machines is then collected on a single machine for processing, which associates together information from related end points. This transformed information is then visualized, which may be performed on a separate or the same machine.

FIG. 2 is a flowchart of an exemplary method for network monitoring of a cloud computing system. The method includes identifying or locating zones 205 within the cloud. These zones may include, for example, a virtual machine(s) for a tenant. Next, the method includes executing 210 a tracing or debugging tool on each of the zones to monitor the internal service operations of the zones for a given period of time. This method step may involve transmitting a signal to each of the zones that informs them to execute the tracing or debugging tool. This tool identifies attributes of internal service operations as mentioned above.

The debugging tool may log the internal service operations attributes of the zones and time stamp each identified attribute in the log. These logs may be saved in any desirable format. The method may include receiving 215 the log files from each of the zones and aggregating 220 the log files of the zones. In accordance with the present technology, the method includes transforming 225 the log file data into a visualization, as well as 230 displaying (or transmitting for display) the visualization. In some embodiments, the method may include converting 235 the visualization into an n-by-n matrix.

FIG. 3 illustrates an exemplary computing device 1 that may be used to implement an embodiment of the present systems and methods. The system 1 of FIG. 3 may be implemented in the contexts of the likes of clients, information display systems, computing devices, terminals, networks, servers, or combinations thereof. The computing device 1 of FIG. 3 includes a processor 10 and main memory 20. Main memory 20 stores, in part, instructions and data for execution by processor 10. Main memory 20 may store the executable code when in operation. The system 1 of FIG. 3 further includes a mass storage device 30, portable storage device 40, output devices 50, user input devices 60, a display system 70, and peripherals 80.

The components shown in FIG. 3 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 3. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 3 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device. Peripherals 80 may include any type of computer support device to add additional functionality to the computing system. Peripherals 80 may include a modem or a router.

The components contained in the computing system 1 of FIG. 3 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A network monitoring system for a cloud computing system, comprising:
a processor; and
a memory for storing executable instructions, the processor executing the instructions to:
identify internal service operations for zones of the cloud computing system, the internal service operations comprising any of processes, code paths, sockets, communications, connection establishments, input/output (I/O) operations, storage operations, and combinations thereof; and
render a visualization of the internal service operations of the cloud computing system, the visualization being zoomable and filterable.

2. The network monitoring system according to claim 1, wherein the processor further executes the instructions to convert the visualization into an n-by-n matrix, wherein n comprises a number of internal service operations within the cloud computing system.

3. The network monitoring system according to claim 1, wherein internal service operations are identified using a debugging or troubleshooting tool that examines process level operations of zones.

4. The network monitoring system according to claim 1, wherein visualization comprises connections between zones that are color coded by connection type.

5. The network monitoring system according to claim 4, wherein any of malware activity, log rotations, process hijacking, bottlenecks, latency, TCP/IP context, and imbalances with respect to zones are identified in the visualization by altering a visual appearance of the zones relative to a visual appearance of other zones that do not have any of these conditions.

6. The network monitoring system according to claim 1, wherein the system identifies internal service operations by examining system operations of virtual machines executing within the zones of the cloud.

7. A method for network monitoring within a cloud computing system, the method comprising:
obtaining, on at least one of a per-connection or a per-packet basis, for each zone in the cloud computing system, internal service operations attributes, the internal service operations attributes being stored in a log file;
aggregating the internal service operations attributes of the log files; and
converting the internal service operations attributes into a visualization of the cloud computing system, the visualization being zoomable and filterable.

8. The method according to claim 7, wherein the internal service operations attributes comprise, for each internal service operation, a time stamp, an application name, a process ID, an application code path, or combinations thereof.

9. The method according to claim 7, further comprising converting the visualization into an n-by-n matrix, wherein n comprises a number of internal service operations within the cloud computing system.

10. The method according to claim 7, wherein internal service operations are obtained using a debugging or troubleshooting tool that examines process level operations of zones.

11. The method according to claim 7, wherein visualization comprises connections between zones that are color coded by connection type.

12. The method according to claim 11, wherein any of malware activity, log rotations, process hijacking, bottlenecks, and imbalances with respect to zones are identified in the visualization by altering a visual appearance of the zones relative to a visual appearance of other zones that do not have any of these conditions.

13. The method according to claim 7, wherein the zones comprise virtual machines executing the cloud.

14. The method according to claim 7, wherein the visualization comprises lines extending between connections between zones of the cloud computing system.

15. The method according to claim 14, wherein the zones are illustrated as boxes and processes are illustrated as ovals disposed proximate to respective zones on which the processes are executed.

16. The method according to claim 15, wherein the ovals are sized proportionally to an amount of CPU time being used by the process.

17. A network monitoring system for a cloud computing system, comprising:
a processor; and
a memory for storing executable instructions, the processor executing the instructions to:
obtaining, on a per-connection or a per-packet basis, for each zone in the cloud computing system, internal service operations attributes, the internal service operations attributes being stored in a log file;
aggregating the internal service operations attributes of the log files; and
converting the internal service operations attributes into a visualization of the cloud computing system, the visualization being zoomable and filterable, the internal service operations attributes comprise, for each internal service operation a time stamp, an application name, a process ID, an application code path, or combinations thereof.

18. The network monitoring system according to claim 17, wherein the visualization comprise a network map of running processes, connections, and dependencies for the zones of the cloud computing system.
